(19) United States
(12) Patent Application Publication
(10) Pub. No.: US 2023/0352918 A1
(43) Pub. Date: Nov. 2, 2023

(54) CABLE HOUSING CONTAINER

(71) Applicant: FURUKAWA ELECTRIC CO., LTD., Tokyo (JP)

(72) Inventors: Takuya MAKI, Tokyo (JP); Koichi MAENO, Tokyo (JP)

(73) Assignee: FURUKAWA ELECTRIC CO., LTD., Tokyo (JP)

(21) Appl. No.: 18/345,039

(22) Filed: Jun. 30, 2023

Related U.S. Application Data
(63) Continuation of application No. PCT/JP2022/042525, filed on Nov. 16, 2022.

(30) Foreign Application Priority Data
Dec. 17, 2021 (JP) 2021-204771

(51) Int. Cl. H02G 3/04; H02G 9/06

(52) U.S. Cl. CPC H02G 3/0406; H02G 9/06

(57) ABSTRACT

Provided is a cable housing container in which when a container body is installed on an installation surface with mortar, positioning of the container body can be reliably performed in a vertical direction on the installation surface, a height can be easily adjusted during the installation process, an installation time can be shortened, deviation can be reduced when a plurality of container bodies are arranged, and the container body can be prevented from being distorted during manufacturing. A bottom plate 11 of a container body 10 has a reaction force acting surface 11a on which a reaction force acts upon contact with mortar M when the container body 10 is installed on a predetermined installation surface S with the mortar M interposed between the container body 10 and the predetermined installation surface S. The reaction force acting surface 11a is formed by formation of a recess in a portion where the thickness T of the bottom plate 11 is 30 mm or more, extends continuously or intermittently, and has a width of 20 mm or less. The reaction force acting surface 11a has an area of 50% or more of an area of a lower surface of the bottom plate 11.

### TECHNICAL FIELD

The present invention relates to a cable housing container that houses cables laid under the ground of a road.

### BACKGROUND ART

Conventionally, there is known a cable housing container including a resin container body to be buried in the ground, the container body being provided with a bottom plate and a pair of side plates extending upward from both sides in a width direction of the bottom plate and having an opening formed in an upper surface thereof (for example, see Patent Document 1).

The container body is typically buried in the following manner: concrete is poured into the excavated portion of the ground to form an installation surface for installing the container body, the container body is installed and positioned on the formed installation surface with mortar, and then surroundings thereof are filled with sand or gravel.
Patent Document 1: Japanese Patent No. 4885263

### DISCLOSURE OF THE INVENTION

### Problems to be Solved by the Invention

The conventional container body is formed by pouring and hardening a resin material into a mold by injection molding or the like. For this reason, it is necessary for the conventional container body to have a uniform thickness as a whole in order to prevent distortion, and to be provided with ribs on an outer surface in order to improve strength.

Therefore, the conventional container body has few flat planes on the lower surface side, and accordingly, when the container body is installed on an installation surface with mortar interposed therebetween, the mortar spread on the installation surface enters gaps on the lower surface side. As a result, it is difficult to adjust a height during the installation process, and there is a risk that height deviations may occur when a plurality of container bodies are arranged.

An object of the present invention is to provide a cable housing container with which when a container body is to be installed on an installation surface via mortar interposed therebetween, positioning of the container body can be reliably performed in a vertical direction with respect to the installation surface, the height can be easily adjusted during the installation process, an installation time can be shortened, deviation can be reduced when a plurality of the container bodies are arranged, and the container body can be prevented from being distorted during manufacturing.

### Means for Solving the Problems

The present invention provides a cable housing container including a container body provided with a bottom plate and a pair of side plates extending upward from both sides in a width direction of the bottom plate and having an opening formed on an upper surface thereof, the container body being made of resin and being adapted to be buried in a ground. The bottom plate of the container body has a reaction force acting surface on which a reaction force acts upon contact with mortar when the container body is installed on a predetermined installation surface with the mortar interposed between the container body and the predetermined installation surface. The reaction force acting surface is formed by formation of a recess in a portion where the thickness of the bottom plate is 30 mm or more, extends continuously or intermittently, and has a width of 20 mm or less. The reaction force acting surface has an area of 50% or more of an area of a lower surface of the bottom plate.

In the cable housing container according to the present invention, the reaction force acting surface has a width of 10 mm or less in the portion where the thickness of the bottom plate is 30 mm or more.

In the cable housing container according to the present invention, the reaction force acting surface is located between a plurality of the recesses in the portion where the thickness of the bottom plate is 30 mm or more.

In the cable housing container according to the present invention, each of the recesses has a circular shape, a triangular shape, a quadrangular shape, or a hexagonal shape.

In the cable housing container according to the present invention, each of the recesses has a depth of 20 mm or more from the reaction force acting surface.

### Effects of the Invention

According to the present invention, when the container body is installed on the installation surface with the mortar interposed therebetween, the reaction force acts on the reaction force acting surface from the mortar, and thus, positioning of the container body can be reliably performed in the vertical direction with respect to the installation surface, whereby the height can be easily adjusted during the installation process, an installation time can be shortened, and deviation can be reduced when the plurality of container bodies are arranged; and since the recess is formed in the bottom plate such that the reaction force acting surface located at the portion where the thickness of the bottom plate is 30 mm or more has the width of 20 mm or less, it is possible to prevent distortion of the container body during molding.

### BRIEF DESCRIPTION OF THE DRAWINGS

FIG. 1 is a schematic diagram of a cable housing container according to the present invention;

FIG. 2 is a cross-sectional view of the cable housing container according to the present invention;

FIGS. 3A to 3D is a perspective view of main components on a lower surface side of a container body according to the present invention;

FIG. 4 is a perspective view of main components on a lower surface side of a conventional container body; and

FIG. 5 is table in which the container body according to the present invention compares with the conventional container body.

### PREFERRED MODE FOR CARRYING OUT THE INVENTION

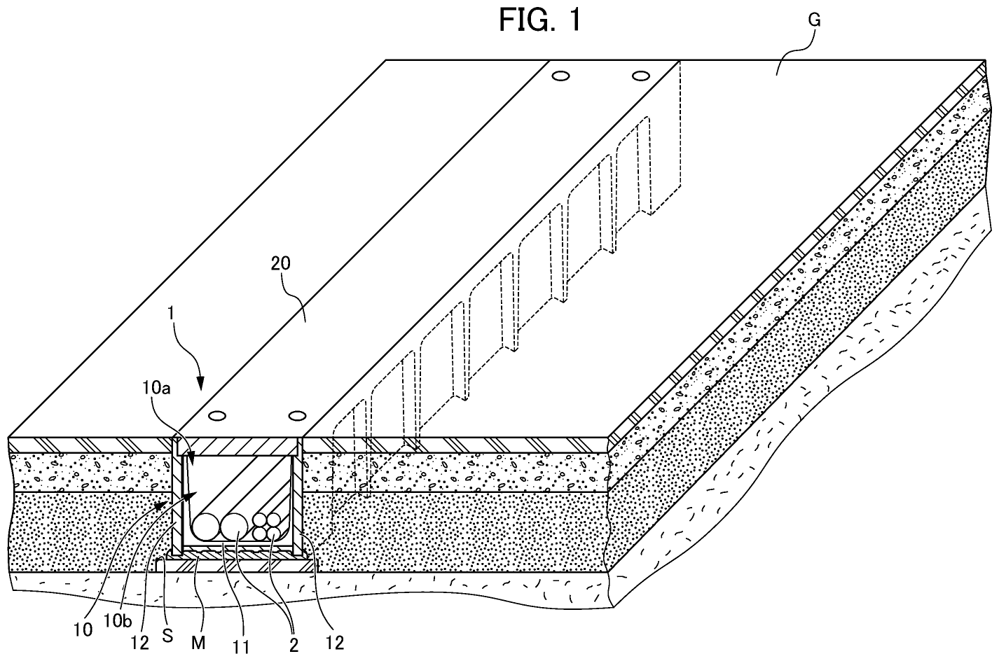

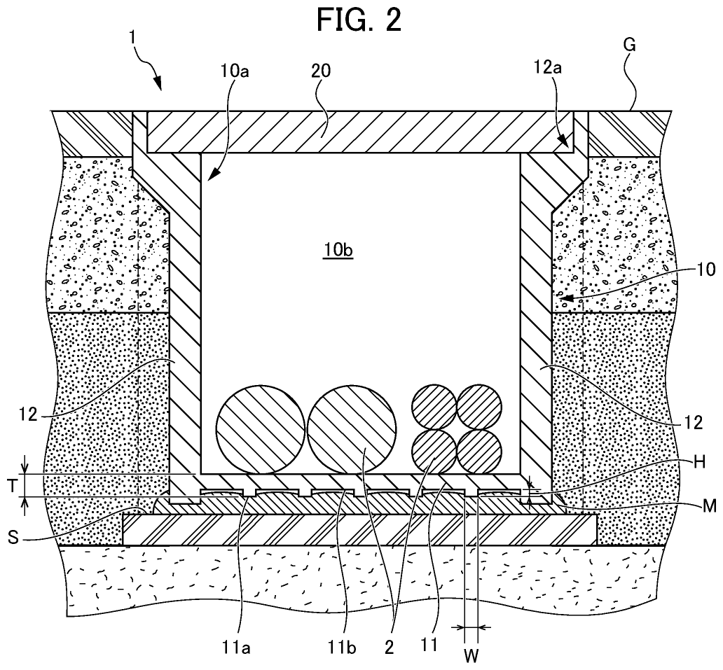

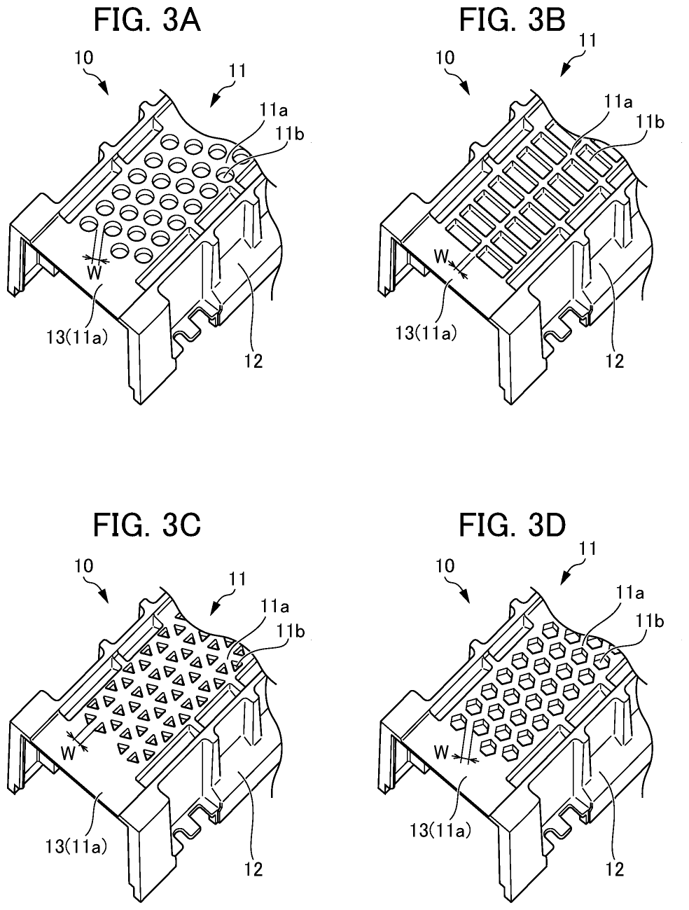

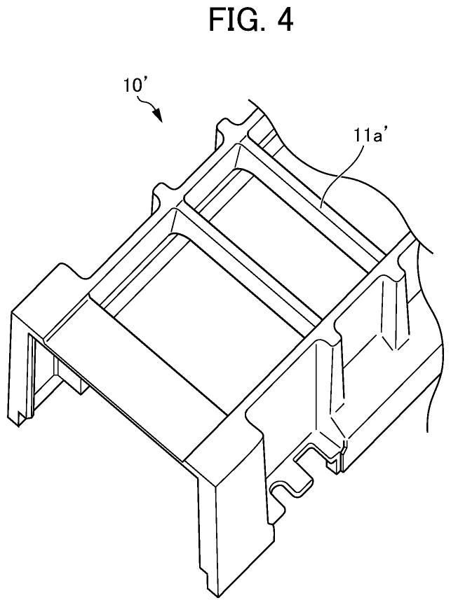

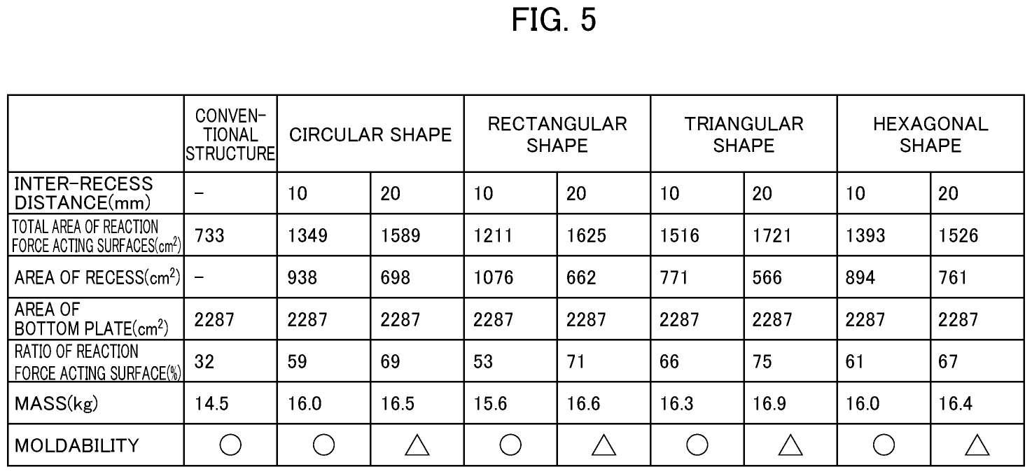

FIGS. 1 to 5 show an embodiment of the present invention. FIG. 1 is a schematic diagram of a cable housing container according to the present invention, FIG. 2 is a cross-sectional view of the cable housing container according to the present invention, FIGS. 3A to 3D is a perspective view of main components on a lower surface side of a container body according to the present invention, FIG. 4 is a perspective view of main components on a lower surface side of a conventional container body, and FIG. 5 is table in which the container body according to the present invention compares with the conventional container body.

A cable housing container 1 of the present embodiment is used for housing a plurality of cables 2 including transmission lines or distribution lines through which power supplied from a power plant is fed to each of demand facilities and communication lines through which signals transmitted and received between a plurality of wireless base station devices and switching centers are sent. As shown in FIGS. 1 and 2, the cable housing container 1 is buried in an asphalt-paved road on which vehicles and pedestrians pass such that an upper surface thereof is flush with a road surface G.

As shown in FIGS. 1 and 2, the cable housing container 1 includes a container body 10 having a U-shaped cross section and an opening 10a formed on the upper surface thereof, and a lid 20 that closes the opening 10a of the container body 10.

The container body 10 is a member made of a recycled resin containing, for example, polyethylene or polypropylene, and is formed by injection molding, for example. The container body 10 includes a bottom plate 11 formed in a rectangular plate shape and a pair of side plates 12 in a width direction extending upward from both end sides in a width direction of the bottom plate 11, and a portion surrounded by the bottom plate 11 and the pair of side plates 12 is a housing space 10b in which the cable 2 is housed. As shown in FIGS. 3A to 3D, the container body 10 is provided with a coupling portion 13 both end sides in a longitudinal direction, and the housing space 10b can be continuously formed in a manner that the coupling portion 13 is coupled to a coupling portion 13 of another container body 10 through an adapter (not shown).

The bottom plate 11 has a configuration in which a thickness T of the coupling portion 13 is less than 30 mm (for example, 10 mm) and a thickness T of portions other than the coupling portion 13 is 30 mm or more (for example, 30 mm). Further, as shown in FIGS. 2, 3A to 3D, when the container body 10 is installed on a predetermined installation surface S with the mortar M, a reaction force acting surface 11a is formed on an entire lower surface of the bottom plate 11 so as to contact with the mortar M and receive a reaction force from the mortar M.

The reaction force acting surface 11a is formed so as to extend continuously with a width W of 10 mm or more and 20 mm or less in a manner that recesses 11b are formed in the bottom plate 11 at a portion where the thickness T of the bottom plate 11 is 30 mm or more (a portion of the bottom plate 11 other than the coupling portion 13). An area of the reaction force acting surface 11a is formed to be 50% or more and 80% or less of the entire area of the lower surface of the bottom plate 11. In addition, the recess 11b has a depth H of 20 mm or more from the reaction force acting surface 11a. Here, the reaction force acting surface 11a extending with the width W of 10 mm or more and 20 mm or less may be formed over the entire lower surface of the portion where the thickness T of the bottom plate 11 is 30 mm or more, or a plurality of intermittently extending reaction force acting surfaces 11a divided by recesses with a width of 20 mm or less, for example may be formed on the lower surface of the bottom plate 11.

The reaction force acting surface 11a of the present embodiment is located between a plurality of recesses 11b.

It is considered that the recess 11b has a circular shape as shown in FIG. 3A, a rectangular shape as shown in FIG. 3B, a triangular shape as shown in FIG. 3C, and a hexagonal shape as shown in FIG. 3D.

The lid 20 is made of a rectangular resin plate-like member. As shown in FIGS. 1 and 2, the lid 20 is formed to have a size in the longitudinal direction equal to a size in the longitudinal direction of the container body 10 and to have sizes in the width direction and the thickness direction capable of being housed in lid receiving portions 12a provided at tops of the pair of side plates 12. The lid 20 is detachably fixed to the container body 10 by a fastening member (not shown).

When the cable housing container 1 configured as described above is installed, first, the installation place and the surrounding soil are excavated, and concrete is poured into the excavated portion to form an installation surface S with a flat upper surface.

Next, the container body 10 is installed with the mortar M laid on the installation surface S. In the container body 10 installed on the installation surface S, the reaction force acting surface 11a formed on the lower surface of the bottom plate 11 contacts with the mortar M, the dead weight of the container body 10 acts onto the mortar M from the reaction force acting surface 11a, and the reaction force acts onto the reaction force acting surface 11a from the mortar M. Therefore, the container body 10 installed on the installation surface S is adjusted in horizontal and vertical directions before the mortar M hardens, and then the posture thereof is maintained.

The container body 10 installed and positioned on the installation surface S is buried in a state where sand and gravel are put around the container body 10 in this order and are compacted using a compaction machine such as a tamper and then asphalt is paved on the gravel.

Here, FIG. 4 is a perspective view of main components on a lower surface side of a conventional container body 10′ having a small area of a reaction force acting surface 11a′. In addition, FIG. 5 is table in which the conventional container body 10′ compares with the container body 10 according to the present invention in which a recess 11b is formed in a circular shape, a rectangular shape, a triangular shape, or a hexagonal shape in the reaction force acting surface 11a located at a portion where the thickness T of the bottom plate 11 is 30 mm or more.

In the table shown in FIG. 5, an inter-recess distance indicates a distance between the recesses 11b (a width W of the reaction force acting surface 11a located at the portion where the thickness T of the bottom plate 11 is 30 mm or more).

As shown in FIG. 5, when each of the container bodies 10 of the present embodiment compares with the conventional container body 10′, it can be seen that the amount of used materials becomes larger, but an area of the reaction force acting surface 11a is large and a ratio of the area of the reaction force acting surface 11a to an area of the lower surface of the bottom plate 11 is larger. Thus, when each of the container bodies 10 of the present embodiment compares with the conventional container body 10′, positioning of the container body can be easily performed in the vertical direction when being installed on the installation surface S with the mortar M.

In addition, as shown in FIG. 5, when an inter-recess distance is 20 mm in each of the container bodies 10 of the present embodiment, the area of the reaction force acting surface 11a is large and the ratio of the area of the reaction force acting surface 11a to the area of the lower surface of the bottom plate 11 is larger, compared with a case where an inter-recess distance is 10 mm. However, in the case of the container body 10 with the inter-recess distance of 20 mm, since the width W of the reaction force acting surface 11a located at the portion where the thickness T of the bottom plate 11 is 30 mm or more becomes large, it can be seen that the distortion generated during molding by injection molding increases and moldability is inferior to that of the container body 10 with the inter-recess distance of 10 mm. Furthermore, when the inter-recess distance is 20 mm in each of the container bodies 10 of the present embodiment, it can be seen that the amount of used materials is greater than that the case where the inter-recess distance is 10 mm.

Therefore, it can be seen among the container bodies 10 of the present embodiment that the container body 10 with an inter-recess distance of 10 mm is superior to the container body 10 with an inter-recess distance of 20 mm in terms of quality and manufacturing costs.

Further, it can be seen among the container bodies 10 with the inter-recess distance of 10 mm of the present embodiment that the container bodies 10 having the recess 11b formed in the circular shape and the rectangular shape are preferable from the view point of the amount of used resin materials.

As described above, the present embodiment provides the cable housing container 1 including the container body 10 provided with the bottom plate 11 and the pair of side plates 12 extending upward from both sides in the width direction of the bottom plate 11 and having the opening 10a formed the upper surface thereof, the container body 10 being made of resin and being adapted to be buried in the ground. The bottom plate 11 of the container body 10 has the reaction force acting surface 11a on which the reaction force acts upon contact with the mortar M when the container body 10 is installed on the predetermined installation surface S with the mortar M interposed between the container body 10 and the predetermined installation surface S. The reaction force acting surface 11a is formed by formation of the recesses 11b in a portion where the thickness T of the bottom plate 11 is 30 mm or more, extends continuously or intermittently, and has a width W of 20 mm or less. The reaction force acting surface 11a has an area of 50% or more of the area of a lower surface of the bottom plate 11.

Thereby, when the container body 10 is installed on the installation surface S with the mortar M, the reaction force acts on the reaction force acting surface 11a from the mortar M, and thus positioning of the container body 10 can be reliably performed in the vertical direction on the installation surface S, whereby the height can be easily adjusted during the installation process, an installation time can be shortened, and deviation can be reduced when the plurality of container bodies 10 are arranged; and since the recess 11b is formed in the bottom plate 11 such that the reaction force acting surface 11a located at the portion where the thickness T of the bottom plate 11 is 30 mm or more has the width W of 20 mm or less, it is possible to prevent distortion of the container body 10 during molding.

Preferably, the reaction force acting surface 11a has a width W of 10 mm or more at the portion where the thickness T of the bottom plate 11 is 30 mm or more.

Thereby, since the reaction from the mortar M can act on the reaction force acting surface 11a, it is possible to prevent a positional displacement in the vertical direction of the container body 10 installed on the installation surface S with the mortar M interposed therebetween.

Preferably, the reaction force acting surface 11a is located between the plurality of recesses 11b in the portion where the thickness T of the bottom plate 11 is 30 mm or more.

Thereby, since the reaction force acting surface 11a can be disposed over the entire lower surface of the portion where the thickness T of the bottom plate 11 is 30 mm or more, it is possible to more reliably prevent a positional displacement in the vertical direction of the container body 10 installed on the installation surface S with the mortar M.

Preferably, the recess 11b has a circular shape, a triangular shape, a quadrangular shape, or a hexagonal shape.

Thereby, the shape of the recess 11b is simplified, and thus, the manufacturing costs of the container body 10 can be reduced.

Preferably, the recess 11b has a depth H of 20 mm or more from the reaction force acting surface 11a.

Thereby, since the bottom plate 11 is reinforced by the portion located between the recesses 11b, the strength of the container body 10 can be improved.

The above-described embodiment shows the cable housing container buried in the road paved with asphalt, but a cable housing container buried in the ground of the road surface not paved with asphalt is also applicable as long as being buried in the ground of a road surface on which heavy objects such as vehicles pass.

The above-described embodiment shows the container body 10 in which the coupling portion 13 is provided between both ends in the longitudinal direction, but is not limited thereto, the coupling portion 13 being a portion where the thickness T of the bottom plate 11 is less than 30 mm. For example, in the case of the container body in which the total thickness of the bottom plate including the coupling portion is 30 mm or more, the recess may be formed over the entire lower surface of the bottom plate, and the reaction force acting surface may be formed so as to extend continuously or intermittently with a width of 20 mm or less. Further, regardless of the presence or absence of the coupling portion, in the case of the container body having a portion where the thickness of the bottom plate is less than 30 mm, it is not necessary to form the reaction force acting surface extending with a width of 20 mm or less in the portion where the thickness of the bottom plate is less than 30 mm.

### EXPLANATION OF REFERENCE NUMERALS

1: cable housing container
10: container body
10a: opening
11: bottom plate
11a: reaction force acting surface
11b: recess
12: side plate
S: installation surface
M: mortar

1. A cable housing container comprising:
a container body including a bottom plate and a pair of side plates extending upward from both sides in a width direction of the bottom plate and having an opening formed on an upper surface thereof, the container body being made of resin and being adapted to be buried in a ground,
the bottom plate of the container body having a reaction force acting surface on which a reaction force acts upon contact with mortar when the container body is installed on a predetermined installation surface with the mortar interposed between the container body and the predetermined installation surface,
the reaction force acting surface being formed by formation of a recess in a portion where the thickness of the bottom plate is 30 mm or more, extending continuously or intermittently, and having a width of 20 mm or less,
the reaction force acting surface having an area of 50% or more of an area of a lower surface of the bottom plate.

2. The cable housing container according to claim 1, wherein
the reaction force acting surface has a width of 10 mm or more in the portion where the thickness of the bottom plate is 30 mm or more.

3. The cable housing container according to claim 1, wherein
the reaction force acting surface is located between a plurality of the recesses in the portion where the thickness of the bottom plate is 30 mm or more.

4. The cable housing container according to claim 3, wherein
each of the recesses has a circular shape, a triangular shape, a quadrangular shape, or a hexagonal shape.

5. The cable housing container according to claim 1, wherein
the recess has a depth of 20 mm or more from the reaction force acting surface.
